(19) United States
(12) Patent Application Publication
(10) Pub. No.: US 2013/0163978 A1
(43) Pub. Date: Jun. 27, 2013

(54) SUPPORT HEAD OF THE BALL JOINT TYPE FOR VIDEOPHOTOGRAPHIC APPARATUSES

(71) Applicant: Abramo Carlesso, Bassano Del Grappa (VI) (IT)

(72) Inventor: Abramo Carlesso, Bassano Del Grappa (VI) (IT)

(73) Assignee: Lino Manfrotto + Co. S.p.A., Cassola (VI) (IT)

(21) Appl. No.: 13/820,519

(22) PCT Filed: Aug. 31, 2011
(86) PCT No.: PCT/IB11/53812

§ 371 Date: Mar. 3, 2013

(30) Foreign Application Priority Data
Sep. 3, 2010 (IT) PD2010A000266

(51) Int. Cl. G03B 17/56

(52) U.S. Cl. CPC G03B 17/561
USPC 396/428

(57) ABSTRACT

A support head (1) of the ball joint type for videophotographic apparatuses comprising: a first element (10) of a ball joint (5) provided with at least one spherical surface portion (11), from which protrudes a stem (15) to which the apparatuses are attachable, a second element (20) of said ball joint (5) configured in such a way that with respect thereto a panoramic axis (Z) of the head (1) is defined, coupled to said at least one spherical surface portion (11) in such a way that the first element (10) is movable with respect to the second element (20) between a first setting position in which the panoramic axis (Z) and a longitudinal axis (W) of the stem (15) are aligned and at least a second setting position in which the aforesaid axes (Z, W) are angularly spaced apart by an angle (A) greater than 90°, a stop (30) suitable for stopping the first element (10) in the second setting position, a travel limiting means (40, 50, 60, 70) selectively movable in order to stop the first element (10) in at least a third setting position, intermediate between the first and the second, in which the panoramic axis (Z) and the longitudinal axis (W) of the stem (15) are angularly spaced from each other by an approximately right angle.

### TECHNICAL FIELD

The subject of the invention is a support head of the ball joint type for videophotographic apparatuses having the features mentioned in the preamble of the main claim.

### TECHNOLOGICAL BACKGROUND

In the field of supports for videophotographic apparatuses it is known to use support heads of the ball joint type, also known as “ball heads”, which have the considerable advantage of permitting setting movements of the equipment in any direction with significant rapidity.

A head of this type permits the displacement of the apparatus about three main axes, normal to one another:
a vertical axis named “panoramic axis”, by means of which the angular sighting along the horizon is adjusted,
a horizontal axis named “tilt axis”, normal to the optical axis of the videophotographic apparatus, by means of which the inclination of the framing with respect to a horizontal plane is adjusted,
an axis named “level” axis, also horizontal and parallel to the optical axis of the videophotographic apparatus, by means of which the inclination of the framing with respect to a vertical plane is adjusted, defining the angle of inclination of the margins of the framing with respect to the horizon.

The level axis can be used in particular for proceeding from horizontal framing, also known by the term “landscape framing”, to vertical framing, also known by the term “portrait framing”, or vice versa.

In order to permit a rapid passage from landscape framing to portrait framing, it is known to provide support heads of the ball joint type with an end stop for rotation about the level axis.

In known applications, the stop is disposed in such a way as to allow a range of movement of 90° about the level axis, with respect to horizontal framing. This solution represents an optimum solution when the bearing plane of the support is horizontal but, when the bearing plane is inclined, it has the drawback of making it complicated to achieve perfectly vertical framing.

For this reason, in other known applications, the end stop is disposed in such as way as to allow a greater range of movement, typically of 100°-105°, which makes it possible to obtain perfectly vertical framing even for bearing planes having a maximum inclination of 10°-15°. In these latter applications the vertical orientation of the apparatus is obtained by means of levelling systems, for example of the bubble type.

The need to use levelling systems renders positioning with respect to the level axis less rapid, even in cases where the bearing plane is perfectly horizontal, representing the main drawback of such a solution compared with that previously described.

### DESCRIPTION OF THE INVENTION

The object of the present invention is to provide a support head of the ball joint type for videophotographic apparatuses, structurally and functionally designed to make it possible to remedy all the drawbacks mentioned with reference to the prior art cited, by combining in a single device the principal advantages of the existing support heads of the ball joint type.

This and other objectives which will become clearer hereinafter are achieved by the invention by means of a support head according to the following claims.

### BRIEF DESCRIPTION OF THE DRAWINGS

The features and advantages of the invention will become clearer from the detailed description of some preferred exemplary embodiments thereof, illustrated by way of non-limiting example with reference to the attached drawings, in which:

FIG. 1 is an axonometric see-through view of a first alternative embodiment of a support head of the ball joint type for videophotographic apparatuses according to the present invention;

FIG. 2 is an axonometric view of some components of the support head of FIG. 1;

FIGS. 3 and 4 are two respective views corresponding to that of FIG. 2, in two different operating states of the support head of FIG. 1;

FIG. 5 is an axonometric view of a second alternative embodiment of the support head of FIG. 1;

FIG. 6 is a sectional side view of a third alternative embodiment of the support head of FIG. 1;

FIG. 7 is a sectional side view of the support head of FIG. 6, in a different operating state;

FIG. 8 is a partial axonometric view of the support head of FIG. 6;

FIGS. 9 and 10 are two sectional side views, corresponding respectively to the views of FIGS. 6 and 7, of a fourth alternative embodiment of the support head of FIG. 1;

FIGS. 11 and 12 are two sectional side views, corresponding respectively to the views of FIGS. 6 and 7, of a fifth alternative embodiment of the support head of FIG. 1;

FIGS. 13 and 14 are two sectional side views, corresponding respectively to the views of FIGS. 6 and 7, of a sixth alternative embodiment of the support head of FIG. 1.

### PREFERRED EMBODIMENTS

In the drawings, the reference 1 indicates as a whole a support head for videophotographic apparatuses which is produced in accordance with the present invention.

The support 1 comprises a ball joint 5 formed by a first element 10 received in rotatable engagement in a second element 20 that can be fixed to a tripod or the like. The first element 10 is provided with a ball 6 having a spherical surface 11 rotatably coupled to a seat 21 defined in the second element 20 of the ball joint 5.

The first element 10 comprises a stem 15 of cylindrical shape protruding from the ball 6 with longitudinal axis of symmetry W, normal to the spherical surface 11. The stem 15, on the opposite side with respect to the ball 6, bears a threaded connector 7 of conventional type to which the videophotographic apparatuses are attachable.

The second element 20 of the ball joint 5 comprises a hollow body 20a bounded by a circular base 22 for coupling to a tripod or the like, by means of attachment means which are conventional in themselves and are not shown, and by a circular aperture 23, opposed to the base 22 and substantially parallel thereto. The ball 6 is partially received in the seat 21 in such a way that the stem 15 protrudes from the second element 20, by way of the aperture 23. The diameter of the aperture 23 is less than the maximum diameter of the ball 6 so as to prevent the first element 10 escaping from the second element 20 as a result of the interference between the surface 11 of the ball 6 and the aperture 23.

The seat 21 of the second element 20 is coupled to the spherical surface 11 of the first element 10 in such a way that the latter is at least partially rotatable with respect to the second element 20 of the ball joint 5 about any axis passing through the centre of the spherical surface 11.

Any rotation of the first element 10 in the seat 21 can be described with respect to a trio of coordinated axes XYZ, rigid with the second element 20 and comprising, according to conventional terminology in the field of support heads, a horizontal tilt axis X, a horizontal level axis Y and a vertical panoramic axis Z. The centre O of the trio of axes XYZ coincides with the centre of the spherical surface 11.

A videophotographic apparatus is normally attachable to the threaded connector 7 in a position in which the axis Y is parallel to the optical axis of the apparatus itself.

In that position the axis X can be used for adjusting the inclination of the framing with respect to a horizontal plane, the axis Y can be used for adjusting the inclination of the margins of the framing with respect to the horizon and the axis Z can be used for adjusting the angular sighting along the horizon.

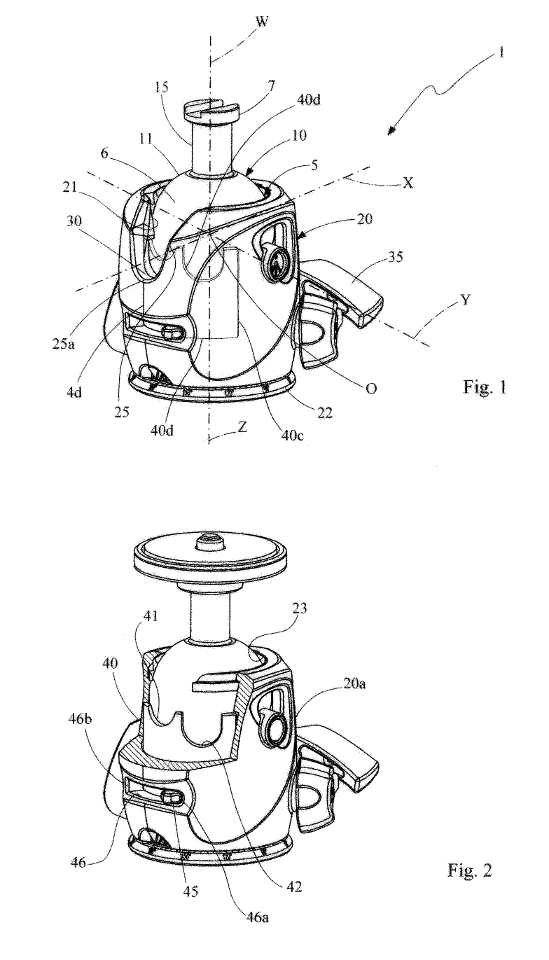

The second element 20 comprises a notch 25 provided on the hollow body 20a and extending longitudinally along the axis Z from the aperture 23, to which it connects, as far as an end 25a comprised between the plane defined by the axes X and Y and the base 22. The notch 25 enables the first element 10 to be rotatable with respect to the second element 20, about the axis Y, between a first setting position in which the panoramic axis Z and the axis W of the stem 15 are aligned (FIGS. 1 and 2) and a second setting position (FIGS. 4, 7, 10 and 12) in which the panoramic axis Z and the axis W of the stem 15 are angularly spaced apart by an angle A greater than 90°, as a result of a rotation about the axis Y. The end 25a of the notch defines a stop 30 suitable for stopping the first element 10 in the second setting position. The stop 30 is formed by a semi-cylindrical surface, having a diameter equal to or slightly greater than that of the stem 15, capable of abutting and bearing on the stem 15 when the first element 10 is in the second setting position, while permitting the rotation thereof about the axis W.

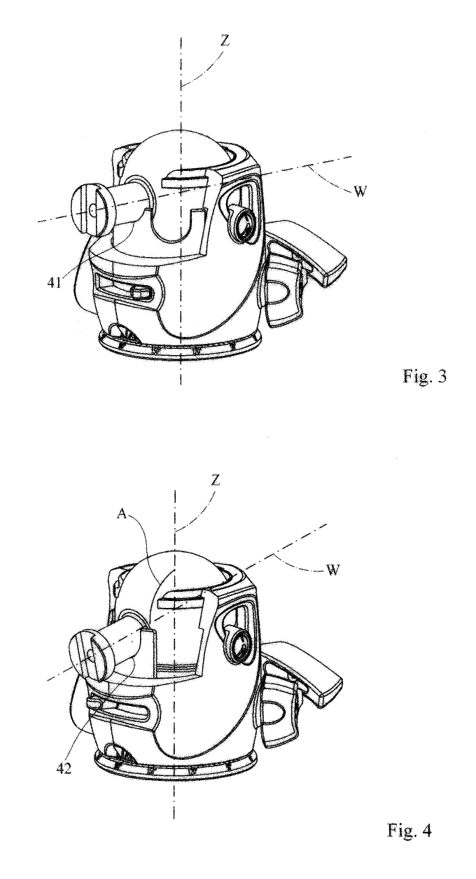

The angle A is typically equal to 100°-105°. This angular range of movement allows in particular the passage between the first setting position in which a videophotographic apparatus attached in a conventional manner to the connector 7 is disposed horizontally (landscape framing) and a third setting position (FIG. 3), angularly spaced with respect to the first position by a right angle and therefore intermediate between the first and the second position, in which the apparatus is disposed vertically (portrait framing) with the axis W of the stem 15 aligned with the axis X. Since the angular range between the first and the second setting position is greater than 90°, it is ensured that portrait framing will be obtained even when the base 22 is inclined with respect to a horizontal plane. For example, an angle A equal to 100° enables portrait framing to be obtained even when the base 22 is rotated through 10° with respect to the axis Y.

According to an alternative embodiment of the invention, on the first element 10 of the ball joint 5 a levelling system (not shown) is provided which is conventional in itself, for example of the bubble type, in order to make it easy to obtain the portrait framing.

The support head 1 comprises a sliding block 36 resiliently connected to the second element 20 of the ball joint 5 by means of a spring 37, which urges the sliding block 36 against the spherical surface 11, in the part facing towards the base 22, for the frictioning of the ball joint 5. The action of the sliding block 36 on the first element 10 of the ball joint makes it possible to damp the setting movements about the axes X, Y, Z, in particular avoiding abrupt dropping of the stem 15 towards the edge of the aperture 23 or the notch 25 which could result in dangerous impacts for a videophotographic apparatus attached to the connector 7.

The support head 1 comprises a locking system for the ball joint 5, operable by means of the handgrip 35 provided on the second element 20 for locking the first element 10 in any relative position with respect to the second element 20. The locking system makes it possible to maintain the advantageous features of rapidity in varying the setting between the first and the second element of the ball joint 5, typical of support heads of this type, and is conventional in itself and therefore not shown.

The support head 1 further comprises a travel limiting means, indicated in the various forms of embodiment described hereinafter by 40, 50, 60 and 70, and which is selectively movable in order to stop the travel of the first element 10 in the third setting position.

With reference to FIGS. 1 to 4, in a first embodiment of the invention the travel limiting means 40 is formed by a thin cylindrical wall portion having an axis coinciding with the panoramic axis Z. The travel limiting means 40 is positioned in the support head 1 in such a way as to be interposed between the first element 10 and the second element 20 of the ball joint 5.

The limiting means 40 comprises a peg 45, radial with respect to the panoramic axis Z and protruding outside the second element 20 through a slot 46, parallel to the base 22. By means of the peg 45, the travel limiting means 40 is rotatable by the operator about the panoramic axis Z away from and towards a stopping position in which the travel limiting means 40 is capable of abutting the first element 10 in the third setting position (FIG. 3). This stopping position is identified as the position in which the peg 45 is brought in abutment against a first end 46a of the slot 46 by means of the rotation of the travel limiting means 40 about the axis Z in an anticlockwise direction for an observer placed along the axis Z with feet on the same side as the base 22.

In other alternative embodiments of the present invention (not shown), the limiting means 40 is housed in a seat provided inside the hollow body 20a, with the peg 45 however protruding from the slot 46, or is attached to the hollow body 20a, outside the latter. In this last variant, the slot 46, since it is not necessary, is not provided.

The travel limiting means 40 comprises a circular base edge 40a, facing towards the base 22, two straight lateral edges 40b, 40c opposed to each other, and an upper edge 40d, opposed to the base edge 40a. On the upper edge 40d a first semi-cylindrical notch 41 is provided, with its axis normal to the panoramic axis Z and suitable for abutting the stem 15 when the travel limiting means 40 is in the stopping position and the first element 10 is in the third setting position, with the axis W disposed along the tilt axis X. In the stopping position the notch 41 is aligned with the stop 30 in a direction parallel to the panoramic axis Z in such a way that the stem 15 is stopped in the third setting position before the second setting position is reached. The diameter of the notch 41 is equal to or slightly greater than that of the stem 15, so as to enable the stem 15 to be received and at the same time to permit rotation about the axis X coinciding with the axis W of the stem 15, even when the first element 10 is in the third setting position.

The travel limiting means 40 comprises a second notch 42, identical to the first notch 41 but displaced further with respect thereto towards the base edge 40a. The second notch 42 is disposed in such a way as to be at least aligned with the stop 30, in a direction normal to the panoramic axis Z, when the peg 45 is brought into abutment against the end 46b of the slot 46, which is opposed to the first end 46a. More generally, the second notch 42 is disposed in such a way as to be aligned with the stop 30 or lowered with respect thereto towards the base 22. In this state the travel limiting means 40 enables the first element 10 to reach the second setting position, abutting the stop 30.

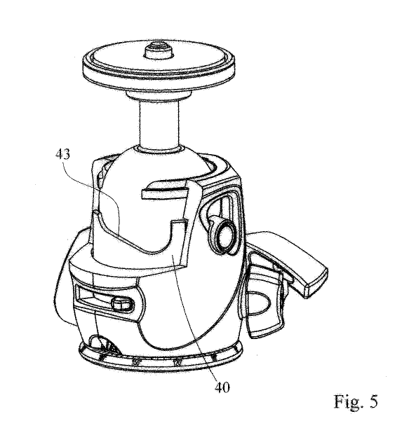

With reference to FIG. 5, in a second embodiment of the invention the travel limiting means 40 comprises, in place of the notches 41, 42, a profile 43 obtained as the envelope of the intersections between the stem 15 and the travel limiting means 40 when the stem 15 is respectively in the second setting position, in the third setting position and in at least a fourth setting position, intermediate between the second and the third. The profile 43 is thus configured in such a way as to abut the stem 15 of the first element 10 in all the positions comprised between the second and the third setting position continuously by means of movement of the peg 45 between the ends 46a, 46b of the slot 46.

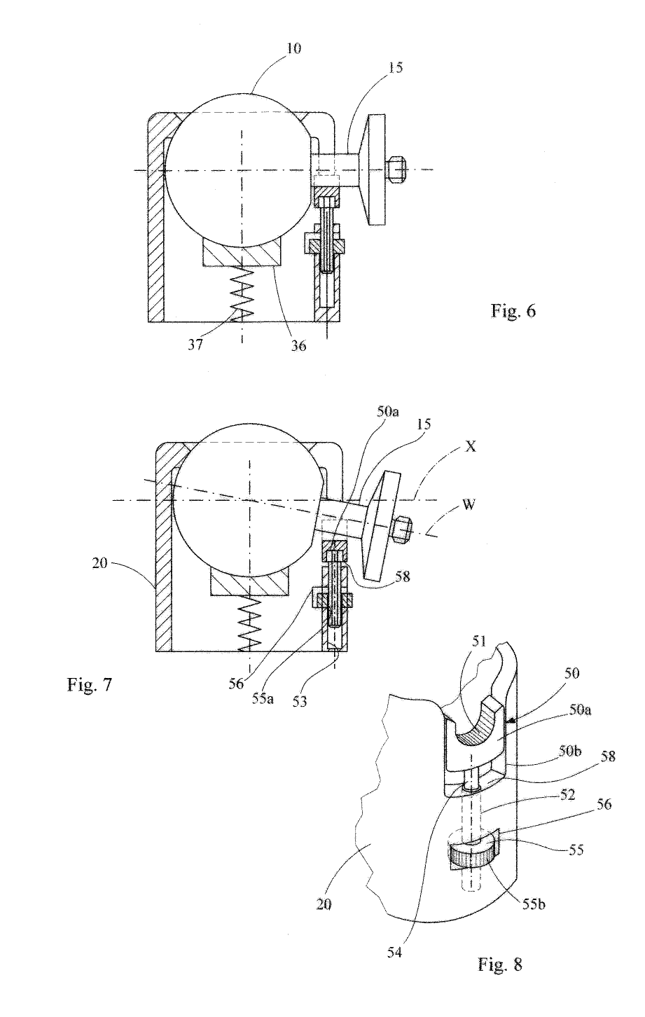

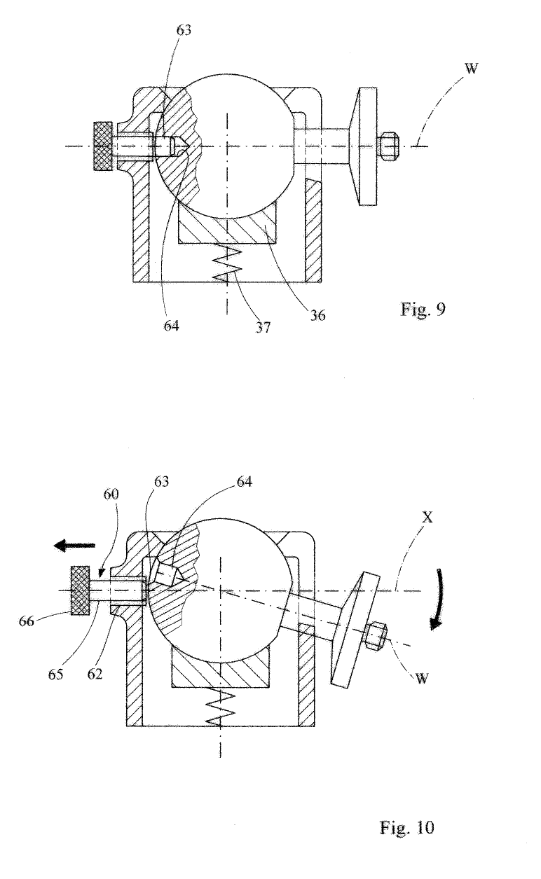

With reference to FIGS. 6 to 10, in a third and a fourth embodiment of the invention, the travel limiting means 50, 60 is translatable along a guide 52, 62 provided on the second element 20 of the ball joint 5, away from and towards a stopping position (FIGS. 6 and 9, respectively) in which the travel limiting means 50, 60 is lockable in order to abut the first element 10 in the third setting position.

In the third embodiment of FIGS. 6 to 8, the travel limiting means 50 is formed by a base 50a provided with a semi-cylindrical notch 51 suitable for abutting the stem 15. The notch 51 is aligned with the stop 30 in a direction parallel to the panoramic axis Z.

The base 50a is movable in a seat 50b along a guide 52 parallel to the panoramic axis Z and lockable along the guide in such a way that the notch 51 abuts the first element 10 in the third setting position and in at least a fourth setting position, intermediate between the second and the third setting position.

The guide 52 is formed by a cylindrical hole 53 provided in the second element 20 of the ball joint 5, parallel to the panoramic axis Z, in which can slide a threaded shank 54, at an axial end of which is fixed the base 50a. The threaded shank 54 is coupled to a respective thread provided on a central hole 55a of a wheel 55 with a milled edge 55b. The wheel 55 is placed in a seating 56 provided in the second element 20 and of such dimensions that the wheel 55 protrudes outside the second element 20 so as to be easily rotatable by acting on the milled edge 55b.

By means of the rotation of the wheel 55, via the threaded coupling between the latter and the shank 54, it is possible to effect the translation of the base 50a continuously between an end stop position in which the base 50a is in abutment against a base wall 58 of the seat 50b and the stopping position in which the axis of the notch 51 is aligned with the tilt axis X. In the end stop position (FIG. 7), the notch 51 is at least aligned with the stop 30 in a direction normal to the panoramic axis Z. More generally, the second notch 51 is disposed in such a way as to be aligned with the stop 30 or lowered further with respect thereto towards the base 22, so as to permit the stopping of the stem 15 by means of abutment against the stop 30.

In the stopping position (FIG. 6), the notch 51 abuts the stem 15 when the first element 10 is in the third setting position, with the axis W disposed along the tilt axis X.

Since the base 50a is lockable in all the intermediate positions between the end stop position and the stopping position, the first element 10 of the ball joint 5 can be stopped in all the positions comprised between the second and the third setting position.

In the fourth embodiment of FIGS. 9 and 10, the first element 10 of the ball joint 5 comprises a seat 64 and the travel limiting means 60 comprises a pin 63 that can be coupled to the seat 64 for stopping the first element 10 in the third setting position.

The seat 64 is provided on the spherical surface 11 aligned with the axis W and in a diametrically opposed position with respect to the stem 15.

The pin 63 comprises a threaded portion 65 coupled to a guide hole 62 which is also threaded, provided on the second element 20 of the ball joint 5 and aligned with the tilt axis X and therefore normal to the panoramic axis Z.

To the pin 63, at its end facing axially towards the outside of the second element 20 of the ball joint 5, there is fixed a cylindrical handgrip 66 with milled edge.

By acting on the handgrip 66 it is possible to move the travel limiting means along the axis X away from and towards a stopping position in which the protuberance 63 can be engaged with the seat 64. This state is reached when the first element 10 is in the third setting position, with the axis W of the stem 15 and of the seat 64 aligned with the axis X of the guide hole 62.

According to a further alternative embodiment of the present invention (not shown), in place of the threaded guide 62 a slidable guide is provided in which the pin 63 is movable with a snap action, with an opposing spring suitable for pushing the pin 63 towards the seat 64.

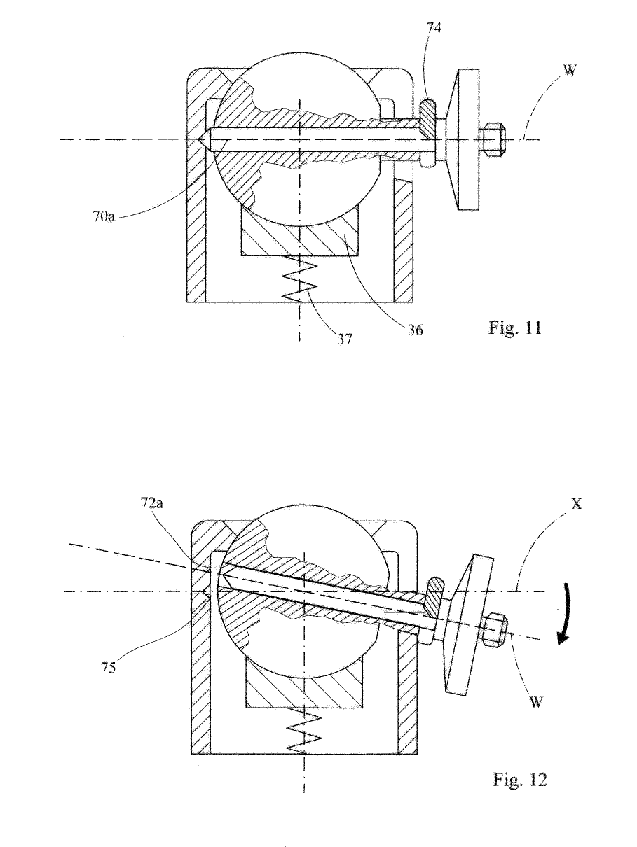

With reference to FIGS. 11 to 14, in a fifth and a sixth embodiment of the invention, the travel limiting means 70a, 70b is translatable along a guide 72a, 72b provided on the first element 10 away from and towards a stopping position in which the travel limiting means 70a, 70b is lockable in order to abut the second element 20 in the third setting position.

In the fifth embodiment of FIGS. 11 and 12, the travel limiting means 70a is formed by a threaded shank translatable with respect to a guide 72a, formed by a threaded hole and provided on the first element 10, along the axis W of the stem 15.

The threaded shank 70a is operated by means of a rotatable ring nut 74 placed around the stem 15 in proximity to the connector 7 in order to be moved away from and towards a stopping position, in which the peg protrudes with respect to the ball 6, on the opposite side with respect to the stem 15.

In the stopping position, the portion of the threaded shank 70a which protrudes from the ball 6 is capable of engaging, when the first element 10 is in the third setting position (FIG. 11), with a respective seat 75, provided on the second element 20 and aligned with the axis X.

When the threaded shank 70a is withdrawn inside the ball 6 the first element 10 of the ball joint 5 is free to rotate about the level axis Y until the second setting position has been reached, with the stem 15 abutting the stop 30 (FIG. 12).

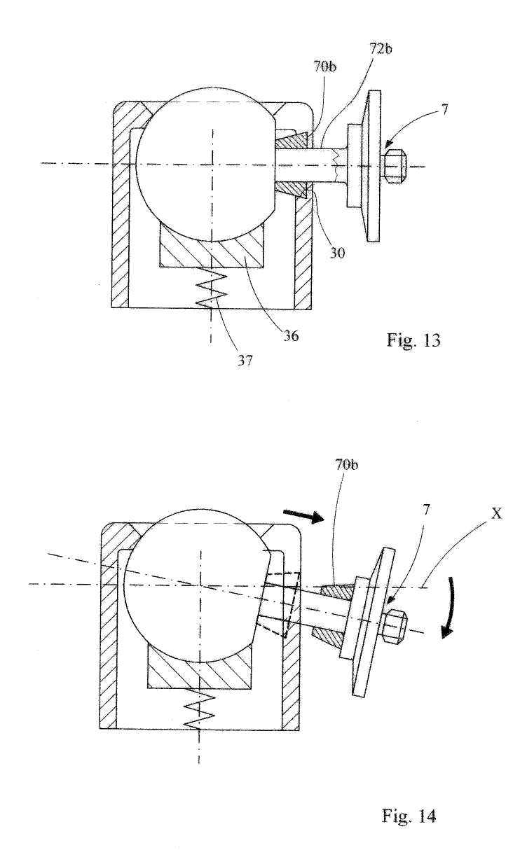

In the sixth embodiment of FIGS. 13 and 14, the travel limiting means 70b is formed by a collar which can slide longitudinally, in the direction of the axis W, along the guide 72b, formed by the surface of the stem 15. In the stopping position the collar 70b is capable of being brought into abutment against the ball 6, being able, in that position, to abut the stop 30 when the first element 10 is in the third setting position (FIG. 13).

When the collar 70b is moved from the stopping position by means of translation towards the connector 7, the first element 10 of the ball joint 5 is free to rotate about the level axis Y until the second setting position is reached, with the stem 15 abutting the stop 30 (FIG. 14).

According to another alternative embodiment of the present invention (not shown), the travel limiting means is formed by a collar rigid with the stem 15, which is telescopically coupled to the ball 6 in such a way as to move the travel limiting means away from and towards a stopping position in which the travel limiting means is capable of abutting the stop 30 when the first element 10 reaches the third setting position.

The invention thus solves the problem posed, obtaining further advantages, including the possibility of bringing the videophotographic apparatus into the position corresponding to portrait framing, while at the same time allowing rotation thereof about the tilt axis.

This makes it possible to rotate the apparatus about the tilt axis, with the pan and level axes locked and with the stem 15 however disposed horizontally, unlike the known ball heads which give preference to rapid locking of the three axes and the locking facility with respect to the accuracy of setting and to the selection of the rotation axis.

This feature is particularly useful in the case where telephoto lenses are used which are equipped with a bracket for anchorage to the support head in order to allow rotation of the body of the device with respect to the attachment point. In this case the present invention makes it possible to transform the spherical support into a device in which only the pan and tilt rotations are permitted, with the level rotation locked in the position in which the stem 15 is disposed horizontally.

1. A support head of the ball joint type for videophotographic apparatuses, comprising:
a first element of a ball joint provided with at least one spherical surface portion, from which protrudes a stem to which said apparatuses are attachable,
a second element of said ball joint configured in such a way that with respect thereto a panoramic axis (Z) of said head is defined, said second element being coupled to said at least one spherical surface portion in such a way that said first element is movable with respect to said second element between at least a first setting position in which said panoramic axis (Z) and a longitudinal axis (W) of said stem are aligned and at least a second setting position in which said panoramic axis (Z) and said longitudinal axis (W) of said stem are angularly spaced apart by an angle (A) greater than 90°, and
a stop suitable for stopping said first element of a ball joint in at least said second setting position,
further comprising a travel limiting means selectively movable in order to stop said first element in at least a third setting position, intermediate between said first and said second position, wherein said panoramic axis (Z) and said longitudinal axis (W) of said stem are angularly spaced apart from each other by an approximately right angle.

2. The support head according to claim 1, wherein said travel limiting means is rotatable about said panoramic axis (Z) away from and towards a stopping position in which said travel limiting means abuts said first element in said third position.

3. The support head according to claim 2, wherein said travel limiting means comprises at least a first notch suitable for abutting said stem when said travel limiting means is in said stopping position and said first element is in said third position.

4. The support head according to claim 3, wherein said travel limiting means comprises at least a second notch suitable for abutting said stem when said first element is in said second position.

5. The support head according to claim 2, wherein said travel limiting means comprises a profile configured in such a way as to abut said first element at least in a fourth position, intermediate between said second and said third position.

6. The support head according to claim 1, wherein said travel limiting means is translatable along at least one guide provided on said second element, away from and towards a stopping position in which said travel limiting means is lockable in order to abut said first element in said third position.

7. The support head according to claim 6, wherein said travel limiting means is lockable along said guide in such a way as to abut said first element in at least a fourth position, intermediate between said second and said third position.

8. The support head according to claim 7, wherein said travel limiting means comprises a notch suitable for abutting said stem in one or more of said second, third and fourth positions.

9. The support head according to claim 6, wherein said guide is approximately parallel to the panoramic axis (Z) of said support head.

10. The support head according to claim 6, wherein said first element comprises a seat and said travel limiting means comprises a pin that can be coupled to said seat in order to stop said first element in said third position.

11. The support head according to claim 10, wherein said seat is provided on said at least one spherical surface portion of said first element.

12. The support head according to claim 10, wherein said guide is approximately normal to the panoramic axis (Z) of said support head.

13. The support head according to claim 1, wherein said travel limiting means is translatable along at least one guide provided on said first element away from and towards a stopping position in which said travel limiting means is lockable in order to abut said second element in said third setting position.

14. The support head according to claim 13, wherein said travel limiting means is formed by a threaded shank movable along a respective threaded hole away from and towards a stopping position in which one end of said travel limiting means protrudes from said first element in order to abut a respective seat when said first element is in said third position.

15. The support head according to claim 13, wherein said travel limiting means is formed by a collar slidable along the surface of said stem, said collar being suitable for abutting said stop when said travel limiting means is in said stopping position and said first element is in said third position.
